(19) United States
(12) Patent Application Publication
(10) Pub. No.: US 2012/0230006 A1
(43) Pub. Date: Sep. 13, 2012

(54) LIGHTING DEVICE

(75) Inventor: Huang-Chen Guo, New Taipei City (TW)

(73) Assignee: UPEC ELECTRONICS CORP., Taipei (TW)

(21) Appl. No.: 13/416,732

(22) Filed: Mar. 9, 2012

Related U.S. Application Data
(60) Provisional application No. 61/451,550, filed on Mar. 10, 2011.

(51) Int. Cl. F21V 9/14; F21V 9/00

(52) U.S. Cl. 362/19; 362/231

(57) ABSTRACT

Example embodiments relate to a lighting device comprising a shell, a plurality of white LEDs and at least one red LED. The white LEDs and red LED(s) are all positioned at the bottom of the shell. The white LEDs, which amount is in a range of 2M to 8M, and red LED, which amount is in a range of 1M to 4M, M represents a constant, are positioned to form an LED array. The light emitted by the white LEDs and red LED(s) forms a combined light to be emitted from the lighting device. The combined light shows the nature which falls within a closed region of CIE 1931 color space, where is defined by a plurality of line segments which intersect each other at points (0.36, 0.55), (0.45, 0.55), (0.55, 0.45), (0.4, 0.3), (0.3, 0.3), (0.32, 0.398), (0.36, 0.378), (0.421, 0.419), (0.431, 0.451) and (0.36, 0.482).

### RELATED APPLICATION

The application claims the benefit under 35 U.S.C. 119(e) of U.S. Provisional Patent Application Ser. No. 61/451,550, filed Mar. 10, 2011 and entitled “Lighting Device,” which is incorporated herein by reference in its entirety.

### TECHNICAL FIELD

The present disclosure relates to a lighting device, and more specifically, relates to a lighting device with LEDs as the light source.

### BACKGROUND

LED (Light Emitting Diode, LED) is of a cold light source, having the characters of power saving, lower consumption, fast initiating, mercury free and longer lifetime. After the technical breakthrough for the blue LED at the end of twentieth century, high power LEDs that emit various colors of light are gradually developed and applied in various kinds of products, such as displays, projectors, lighting device, etc. Therefore, LEDs definitely are the light source attracting most attention.

However, since the light emitted from LEDs are monochromatic, this nature limits LEDs, so other light source to replace the light source emitting light with broad band spectrum, such as white light, is still seeking. To solve this problem, it is popular to use one single LED emitting light with shorter wavelength, such as blue light or ultra-violet light, with a phosphor material positioned on the optical path of the LED to transform a part of or all of the light emitted from the LED to the light which spectrum comprises light with longer wavelength, such as green light, red light, etc. Such LED to emit white light is called white LED and it is capable to replace incandescent bulbs or tubes. However, the phosphor material may be affected by the heat generated during LED's operation to decay and lower its efficiency, so more problems, such as unstable color temperature, will occur after using such LEDs for a while. Therefore, it still needs to find out better solution to these undesired problems.

### SUMMARY

Present embodiments relate generally to providing a lighting device, with combining colorful light emitted from the LEDs with various color in the shell to form a combined light. The combined light possesses the characters of a white light, and falls into a closed region of CIE 1931 color space defined by a plurality of lines which are intersected at the XY coordinates (0.36, 0.55), (0.45, 0.55), (0.55, 0.45), (0.4, 0.3), (0.3, 0.3), (0.32, 0.398), (0.36, 0.378), (0.421, 0.419), (0.431, 0.451) and (0.36, 0.482).

According to an example embodiment, a lighting device is provided, comprising a shell, a plurality of white LEDs, and at least one red LED. The white LEDs are positioned at the bottom of the shell. The at least one red LED is positioned at the bottom of the shell, and arranged in an LED array with the white LEDs, which amount is between 2M to 8M, wherein the amount of the red LED is between 1M to 4M, and M denotes a constant. Wherein, the light emitted from the white LEDs and the red LED forms a combined light emitted from the lighting device, the combined light possesses characteristics that fall in a closed region of CIE 1931 color space defined by a plurality of lines which are intersected at XY coordinates (0.36, 0.55), (0.45, 0.55), (0.55, 0.45), (0.4, 0.3), (0.3, 0.3), (0.32, 0.398), (0.36, 0.378), (0.421, 0.419), (0.431, 0.451) and (0.36, 0.482).

According to another example embodiment, the arrangement of the positions of the white LEDs and the at least one red LED is not limited; however, preferably forming an LED array. Second, the amount of the white LEDs and the at least one red LED is not limited either, for example, the proportion of the amount of the white LEDs to the amount of the at least one red LED could be 5:3, and one of the examples is established by five white LEDs and three red LEDs. The white LEDs and the at least one red LED could be alternately positioned in the LED array to facilitate forming the combined light in a more natural way. If considering the positions of every array element in the LED array to correspond to a three-level array A, according to former exemplary proportion for the amount, the arrangement of the positions of the white LEDs and the at least one red LED is variable; however, it is not limited to these examples, such as, example 1: the positions of the white LEDs in the LED array correspond to the positions of the array elements, a1,1, a1,2, a1,3, a3,1 and a3,3, in the three-level array A and the positions of the at least one red LED in the LED array corresponds to the positions of the array elements, a2,1, a2,2 and a2,3, in the three-level array A; example 2: the positions of the white LEDs in the LED array correspond to the positions of the array elements, a1,1, a1,3, a2,2, a3,1 and a3,3, in the three-level array A and the positions of the at least one red LED in the LED array corresponds to the positions of the array elements, a2,1, a2,3 and a3,2, in the three-level array A; example 3: the positions of the white LEDs in the LED array correspond to the positions of the array elements, a1,2, a2,1, a2,3, a3,1 and a3,3, in the three-level array A and the positions of the at least one red LED in the LED array corresponds to the positions of the array elements, a1,1, a1,3 and a3,2, in the three-level array A; and example 4: the positions of the white LEDs in the LED array correspond to the positions of the array elements, a2,1, a2,2, a2,3, a3,1 and a3,3, in the three-level array A and the positions of the at least one red LED in the LED array corresponds to the positions of the array elements, a1,1, a1,3 and a3,2, in the three-level array A.

According to another example embodiment, the lighting device could operationally further comprise at least one green LED positioned at the bottom of the shell. The amount of the at least one green LED could be limited between 1M to 3M, wherein M is a constant. Light emitted from the at least one green LED and the aforementioned white LEDs and the at least one red LED forms the combined light emitted from the lighting device light. Similarly, the amount and the position arrangement of the at least one green LED are not limited either; for example, the proportion of the amount of the white LEDs to the amount of the at least one red LED and to the amount of the at least one green LED could be 4:3:1, and one of the examples could be established by four white LEDs, three red LEDs and one green LED. The at least one green LED could be alternately positioned in the LED array with other white LEDs and the at least one red LEDs. If considering the positions of every array element in the LED array to correspond to a three-level array B, according to former exemplary proportion for the amount, the arrangement of the positions of the at least one green LED, the white LEDs and the at least one red LED is variable; however, it is not limited to these examples, such as, example 1: the positions of the white LEDs in the LED array correspond to the positions of the array elements, b1,1, b1,3, b3,1 and b3,3, in the three-level array B, the positions of the at least one red LED in the LED array corresponds to the positions of the array elements, b2,1, b2,2 and b2,3, in the three-level array B, and the positions of the at least one green LED in the LED array correspond to the position of the array element, b1,2, in the three-level array B; example 2: the positions of the white LEDs in the LED array correspond to the positions of the array elements, b1,1, b1,3, b3,1 and b3,3, in the three-level array B, the positions of the at least one red LED in the LED array corresponds to the positions of the array elements, b2,1, b2,3 and b3,2, in the three-level array B, and the positions of the at least one green LED in the LED array correspond to the positions of the array element, b2,2, in the three-level array B; example 3: the positions of the white LEDs in the LED array correspond to the positions of the array elements, b2,1, b2,3, b3,1 and b3,3, in the three-level array B, the positions of the at least one red LED in the LED array corresponds to the positions of the array elements, b1,1, b1,3 and b3,2, in the three-level array B, and the positions of the at least one green LED in the LED array correspond to the position of the array element, b1,2, in the three-level array B; and example 4: the positions of the white LEDs in the LED array correspond to the positions of the array elements, b2,1, b2,3, b3,1 and b3,3, in the three-level array B, the positions of the at least one red LED in the LED array corresponds to the positions of the array elements, b1,1, b1,3 and b3,2, in the three-level array B, and the positions of the at least one green LED in the LED array correspond to the positions of the array elements, b2,2, in the three-level array B.

Further, according to another example embodiment, the aforementioned closed region comprises six points which XY coordinates in the 1931 CIE color space are (0.4476, 0.4074), (0.3485, 0.3517), (0.3101, 0.3163), (0.3127, 0.3290), (0.333, 0.333) and (0.313, 0.329) respectively, therefore, the above combined light indeed shows the characters of white light.

Except the aforementioned elements, example embodiments of the lighting device could also optionally comprise at least one optical membrane, an electrical connector or a plurality of frames for providing additional function, such as, optical adjustment, power connection, or positioning. Preferably, the optical membrane, which could be a green polarizer, is positioned on the shell, the electrical connector is electrically connected to the white LEDs, the at least one red LED and/or the at least one green LED for supplying power. More preferably, a screwed connector is used as the electrical connector adapted for the connector of the light bulbs. The frames could be positioned via a fixing device fixed on the bottom of the shell, and preferably pivoting from the fixing device to allow fast and simple assembled process, such as pivotally rotating the frames to get the frames protruding from the shell wedged with installation spot, when the assembling of the lighting device is needed.

Therefore, according to above illustration, example embodiments of the lighting device uses various colors of LEDs to forms combined light showing the characters falling in a closed region in the CIE 1931 COLOR SPACE defined by a plurality of lines which are intersected at XY coordinates (0.36, 0.55), (0.45, 0.55), (0.55, 0.45), (0.4, 0.3), (0.3, 0.3), (0.32, 0.398), (0.36, 0.378), (0.421, 0.419), (0.431, 0.451) and (0.36, 0.482).

### BRIEF DESCRIPTION OF THE DRAWINGS

The accompanying drawings are included to provide a further understanding of example embodiments, and are incorporated in and constitute a part of this description. The drawings illustrate example embodiments, and together with the description, serve to explain the principles of example embodiments. There is shown:

FIG. 1 shows a perspective view of the lighting device according to an example embodiment;

FIG. 2 shows a cross-section view of the lighting device in FIG. 1 along AA line;

FIG. 3 shows the enlarged S structure of the lighting device in FIG. 2;

FIG. 4 shows an exemplary view of the optical character of the combined light emitted from the lighting device according to an example embodiment, arrow C designating the location of Planck black-body thermal radiation constant;

FIG. 5 shows another exemplary view of the optical character of the combined light emitted from the lighting device according to an example embodiment;

FIG. 6A to FIG. 6D shows various kinds of arrangements of the LED array of the lighting device according to an example embodiment; and

FIG. 7A to FIG. 7D shows various kinds of arrangements of the LED array of the lighting device according to an example embodiment.

### DETAILED DESCRIPTION

In the following description, numerous details are set forth in order to provide a thorough understanding of example embodiments with reference to drawings which are not drawn in an exact ratio. It will be appreciated by one of ordinary skill in the art that variations of these specific details are possible while still achieving the results of example embodiments. In other instances, well-known backgrounds are not described in detail in order not to unnecessarily obscure example embodiments.

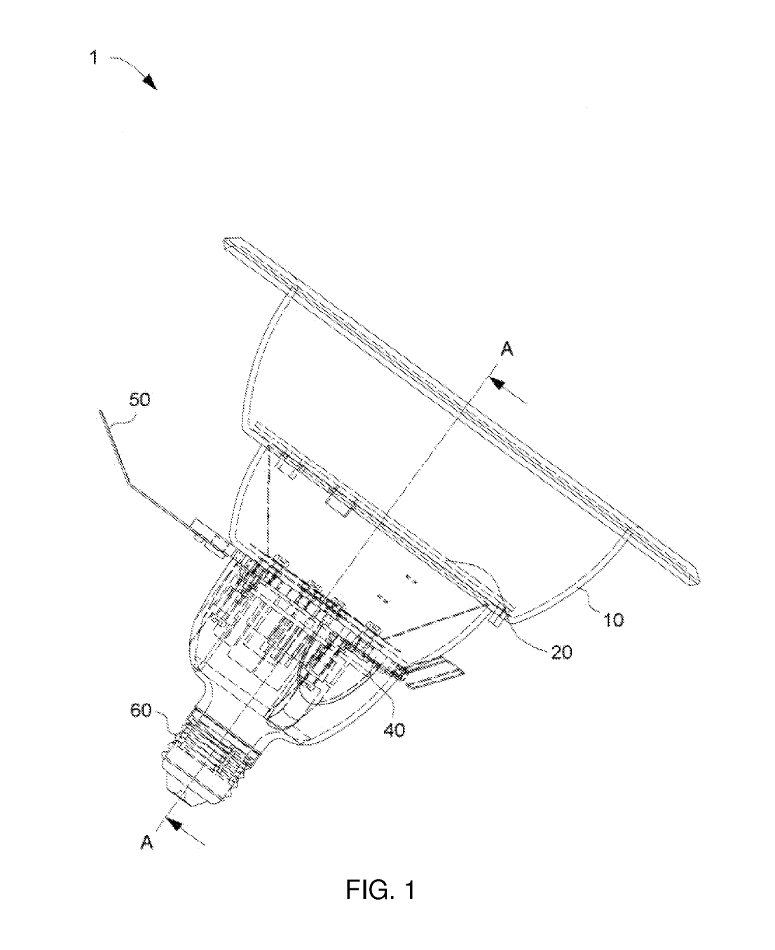

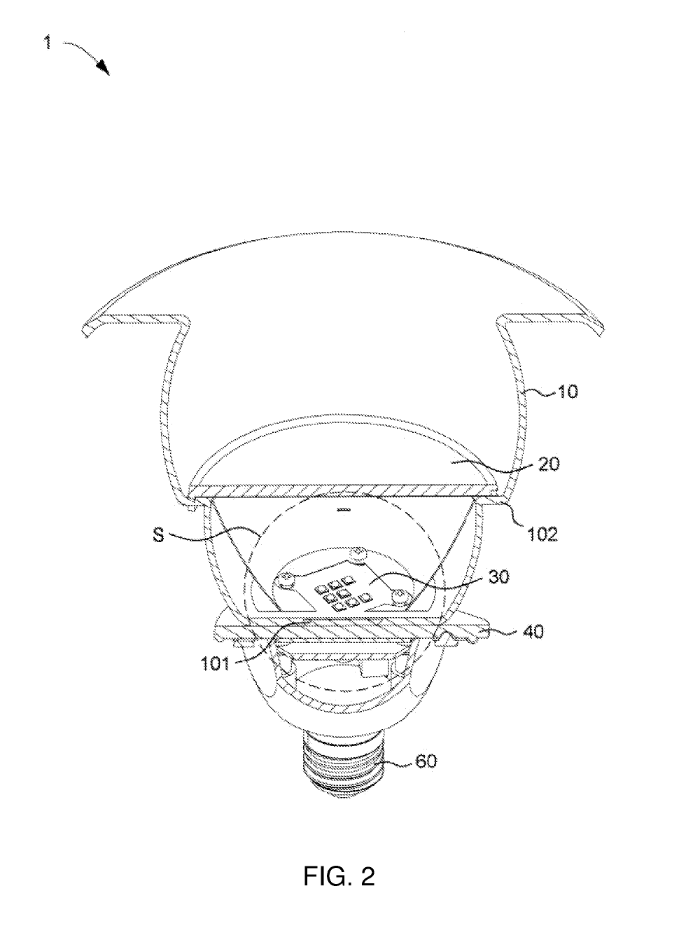

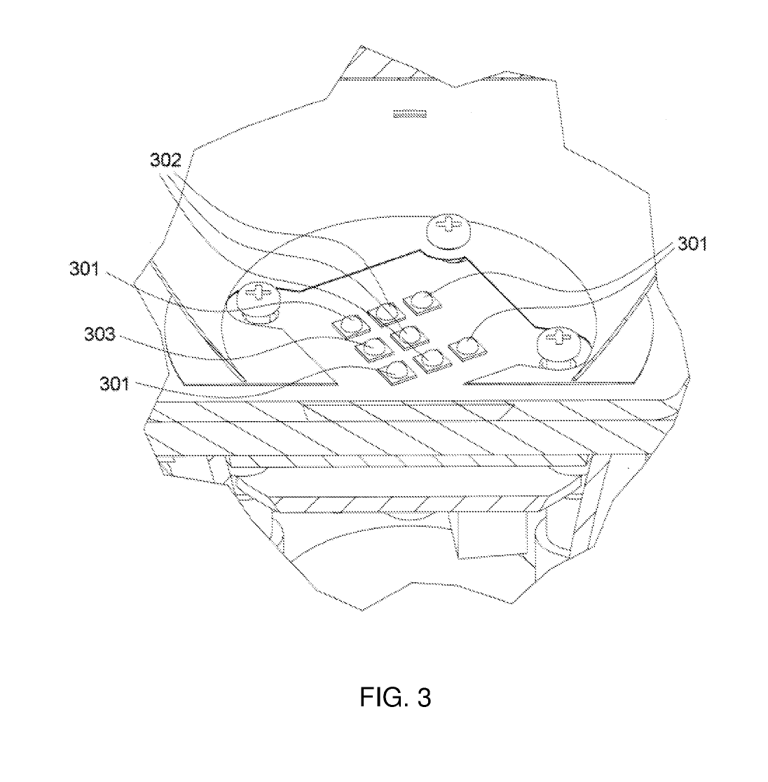

Please refer to FIGS. 1-3, wherein FIG. 1 shows a perspective view of the lighting device according to an example embodiment, FIG. 2 shows a cross-section view of the lighting device in FIG. 1 along AA line, and FIG. 3 shows the enlarged S structure of the lighting device in FIG. 2. As shown, the lighting device 1 comprises a shell 10, an optical membrane 20, a LED array 30, a fixing device 40, three frames 50 and an electrical connector 60. Here the shell 10 is not limited but preferably made by reflective material, such as metal. The shape of the shell 10 shown in the figures is only used to illustrate exemplary embodiments.

The optical membrane 20 is positioned on the shell 10, and specifically, a rib 102 is formed on the shell 10 for forming a plurality of recesses or bumps, and correspondingly, a plurality of bumps or recesses (not shown) are formed on the optical membrane 20, therefore the optical membrane 20 could be correspondingly wedged with, fixed on or by other means to get positioned at the rib 102 of the shell 10, and preferably in the light path of the LED array 30. Therefore, the optical membrane 20 could adjust the optical character of the light emitted from the LED array 30, such as evening the intensity conformity of the light. The optical membrane 20 could be formed by various kind of membranes layered together to adjust more types of optical character, and one example among them is a green polarizer.

In the present embodiment, the LED array 30 comprises at least two kinds of LEDs emitting light of different colors respectively, for example, the white LEDs 301, the red LED 302 and the green LED 303. The respective amounts of these LEDs 301, 302, 303 emitting light of different colors are not limited, but preferably the amount of the white LEDs 301 falls within 2M to 8M, the amount of the red LED 302 falls within 1M to 4M, and the amount of the green LED falls within 1M to 3M, M as a constant. The present embodiment takes four white LEDs 301, three red LED 302 and one green LED 303 as example. These white LEDs 301, red LED 302 and green LED 303 are all positioned at the bottom 101 of the shell 10, and the arrangement of the positions of these white LEDs 301, red LED 302 and green LED 303 in the LED array 30 could be various. For example, here the white LEDs 301 are positioned at the four corners of the LED array 30, and the red LED 302 and the green LED 303 are positioned between any two of the white LEDs 301, and each possible position in the LED array 30 corresponds to an array element of a three-level array B as following:

$$B = \vert \begin{matrix}{b}_{1 , 1} , {b}_{1 , 2} , {b}_{1 , 3} \\ {b}_{2 , 1} , {b}_{2 , 2} , {b}_{2 , 3} \\ {b}_{3 , 1} , {b}_{3 , 2} , {b}_{3 , 3}\end{matrix} \vert$$

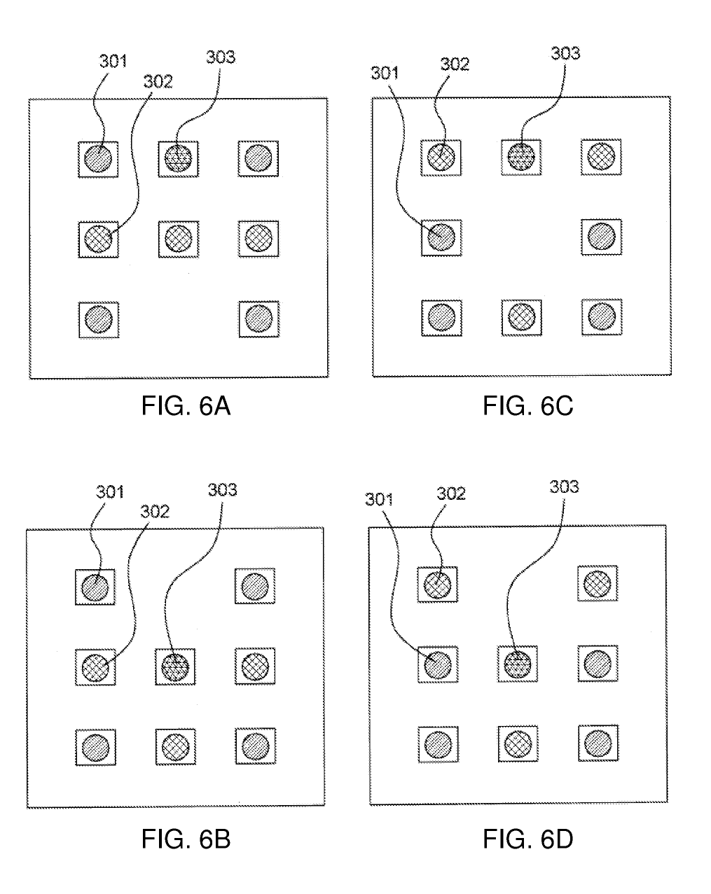

clearly, the positions of the white LEDs 301 in the LED array 30 correspond to the positions of the array elements, b1,1, b1,3, b3,1 and b3,3, in the three-level array B, the position of the red LED 302 in the LED array 30 corresponds to the positions of the array elements, b2,1, b2,2 and b2,3, in the three-level array B, and the position of the green LED 303 in the LED array 30 corresponds to the position of the array element, b1,2, in the three-level array B, as shown in FIG. 6A. However, other arrangement to set the positions of the white LEDs 301, the red LED 302 and the green LED 303 are possible, for example, as shown in FIG. 6B to FIG. 6D. In FIG. 6B, the positions of the white LEDs 301 in the LED array 30 correspond to the positions of the array elements, b1,1, b1,3, b3,1 and b3,3, in the three-level array B, the position of the red LED 302 in the LED array 30 corresponds to the positions of the array elements, b2,1, b2,3 and b3,2, in the three-level array B, and the position of the green LED 303 in the LED array 30 corresponds to the positions of the array elements, b2,2, in the three-level array B. In FIG. 6C, the positions of the white LEDs 301 in the LED array 30 correspond to the positions of the array elements, b2,1, b2,3, b3,1 and b3,3, in the three-level array B, the position of the red LED 302 in the LED array 30 corresponds to the positions of the array elements, b1,1, b1,3 and b3,2, in the three-level array B, and the position of the green LED 303 in the LED array 30 corresponds to the position of the array element, b1,2, in the three-level array B. In FIG. 6D, the positions of the white LEDs 301 in the LED array 30 correspond to the positions of the array elements, b2,1, b2,3, b3,1 and b3,3, in the three-level array B, the position of the red LED 302 in the LED array 30 corresponds to the positions of the array elements, b1,1, b1,3 and b3,2, in the three-level array B, and the position of the green LED 303 in the LED array 30 corresponds to the positions of the array elements, b2,2, in the three-level array B. By alternately positioning the white LEDs 301, the red LED 302 and the green LED 303, a combined light emitted from the lighting device 1 is naturally formed by light emitted from the white LEDs 301, the red LED 302 and the green LED 303.

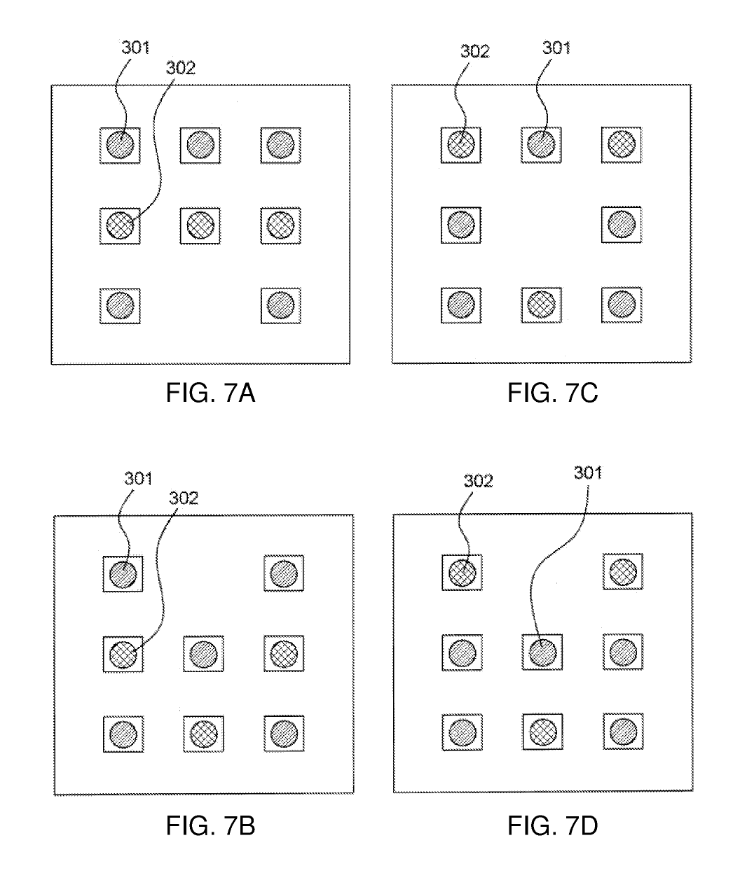

Alternately, it is possible to establish the LED array 30 by merely the white LEDs 301 and the red LEDs 302, as shown in FIG. 7A to FIG. 7D. Here, the proportion of the amount of the white LEDs 301 to the amount of the red LEDs 302 is 5:3, and specifically, five white LEDs 301 to three red LEDs 302. The white LEDs 301 and the red LEDs 302 could be alternately positioned in the LED array 30 to form the combined light in a more nature way. If matching each possible position of the LED array 30 corresponding to a three-level array A as following:

$$A = \vert \begin{matrix}{a}_{1 , 1} , {a}_{1 , 2} , {a}_{1 , 3} \\ {a}_{2 , 1} , {a}_{2 , 2} , {a}_{2 , 3} \\ {a}_{3 , 1} , {a}_{3 , 2} , {a}_{3 , 3}\end{matrix} \vert$$

The arrangement of the positions of the white LEDs 301 and the red LEDs 302 is variable. For example, as shown in FIG. 7A, the positions of the white LEDs 301 in the LED array 30 correspond to the positions of the array elements, a1,1, a1,2, a1,3, a3,1 and a3,3, in the three-level array A and the position of the red LEDs 302 in the LED array 30 correspond to the positions of the array elements, a2,1, a2,2 and a2,3, in the three-level array A; as shown in FIG. 7B, the positions of the white LEDs 301 in the LED array 30 correspond to the positions of the array elements, a1,1, a1,3, a2,2, a3,1 and a3,3, in the three-level array A and the position of the red LEDs 302 in the LED array 30 correspond to the positions of the array elements, a2,1, a2,3 and a3,2, in the three-level array A; as shown in FIG. 7C, the positions of the white LEDs 301 in the LED array 30 correspond to the positions of the array elements, a1,2, a2,1, a2,3, a3,1 and a3,3, in the three-level array A and the position of the red LEDs 302 in the LED array 30 correspond to the positions of the array elements, a1,1, a1,3 and a3,2, in the three-level array A; and as shown in FIG. 7D, the positions of the white LEDs 301 in the LED array 30 correspond to the positions of the array elements, a2,1, a2,2, a2,3, a3,1 and a3,3, in the three-level array A and the position of the red LEDs 302 in the LED array 30 correspond to the positions of the array elements, a1,1, a1,3 and a3,2, in the three-level array A.

The fixing device 40 of the present embodiment is fixed between the bottom 101 of the shell 10 and the electrical connector 60 by fasteners, such as screws. The frames 50 of the lighting device 1 are pivoted from the fixing device 40 for support the whole lighting device 1, and preferably, the frames 50 are evenly positioned at the edge of the fixing device 40 for stability. Therefore, when assembling the lighting device 1 is needed, the frames 50 could be pivotally rotated to get the part of the frames 50 protruding from the shell 10 wedged with the installation spot to get assembled.

The electrical connector 60 electrically connects to the white LEDs 301, the red LED 302 and/or the green LED 303 to provide power. The exemplary shape of the electrical connector 60 is a screwed connector adapted for the connector of the light bulbs. The electrical connector 60 could optionally comprises at least one electrical device or circuit for adjusting the electrical characters of the power source for the white LEDs 301, the red LED 302 and/or the green LED 303, such as the shape of the waves, voltage or other characters.

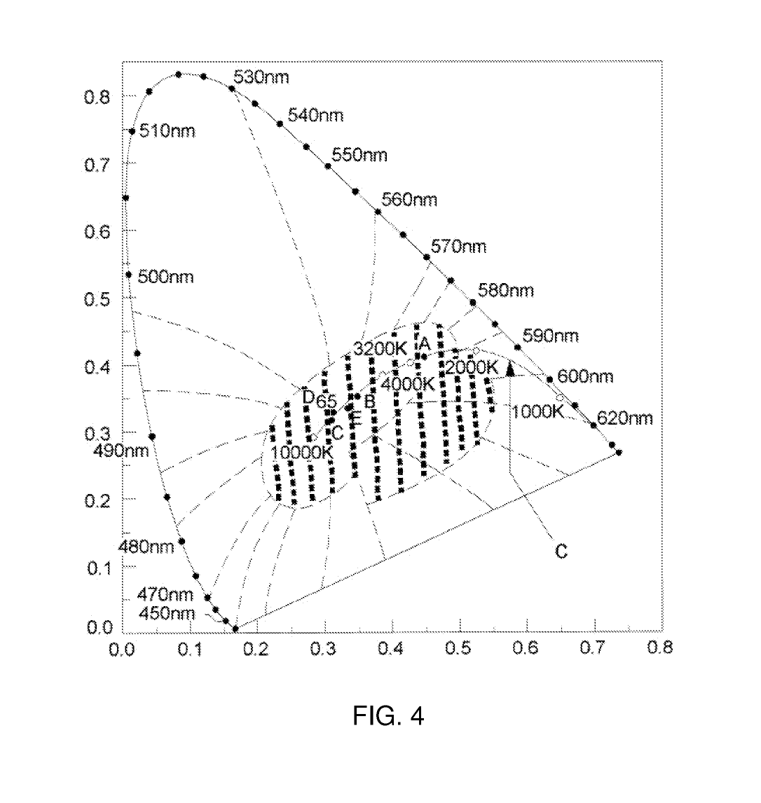

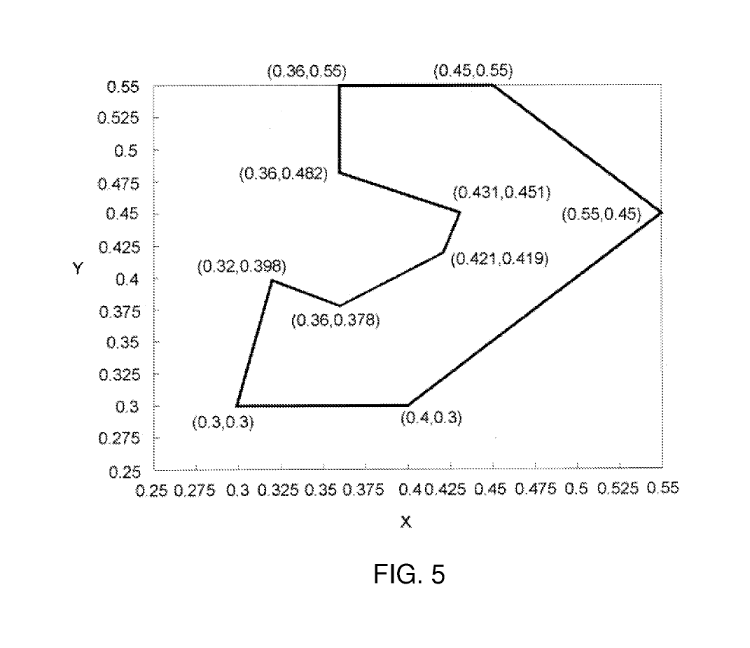

Please refer to FIG. 4 and FIG. 5, wherein FIG. 4 shows an exemplary view of the optical character of the combined light emitted from the lighting device according to an example embodiment, arrow C designating the location of Planck black-body thermal radiation constant, FIG. 5 shows another exemplary view of the optical character of the combined light emitted from the lighting device according to an example embodiment. As shown in FIG. 4, the combined light shows the character to fall within a closed region marked by black dots in CIE 1931 COLOR SPACE, the closed region comprising six points which XY coordinates are (0.4476, 0.4074), (0.3485, 0.3517), (0.3101, 0.3163), (0.3127, 0.3290), (0.333, 0.333) and (0.313, 0.329). Therefore, the combined light indeed owns the characters of white light. However, in example embodiments, for further approaching the characters of white light, the optical characters of the combined light could be within in the closed region in CIE 1931 COLOR SPACE as shown in FIG. 5, defined by a plurality of lines which are intersected at XY coordinates (0.36, 0.55), (0.45, 0.55), (0.55, 0.45), (0.4, 0.3), (0.3, 0.3), (0.32, 0.398), (0.36, 0.378), (0.421, 0.419), (0.431, 0.451) and (0.36, 0.482).

Therefore, according to above illustration, the lighting device in example embodiments combines the light of various colors emitted by various kind of colors of LEDs positioned in the shell to form the combined light showing the characters falling in a closed region in the CIE 1931 COLOR SPACE defined by a plurality of lines which are intersected at XY coordinates (0.36, 0.55), (0.45, 0.55), (0.55, 0.45), (0.4, 0.3), (0.3, 0.3), (0.32, 0.398), (0.36, 0.378), (0.421, 0.419), (0.431, 0.451) and (0.36, 0.482). So, the light emitted from the lighting device is more similar to white light.

Finally, those having ordinary skill in the art should appreciate that they can readily use the disclosed conception and example embodiments as a basis for designing or modifying other structures for carrying out the same purpose without departing from the spirit and scope as claimed in the appended claims.

1. A lighting device, comprising:
a shell;
a plurality of white LEDs positioned at the bottom of the shell; and
at least one red LED positioned at the bottom of the shell, said at least one red LED arranged in an LED array with the white LEDs, which amount is between 2M to 8M, whereas the amount of the at least one red LED is between 1M to 4M, and M denotes a constant;
wherein the light emitted from the white LEDs and the at least one red LED forms a combined light emitted from the lighting device, the combined light possesses characteristics that fall in a closed region of CIE 1931 color space defined by a plurality of lines which are intersected at XY coordinates (0.36, 0.55), (0.45, 0.55), (0.55, 0.45), (0.4, 0.3), (0.3, 0.3), (0.32, 0.398), (0.36, 0.378), (0.421, 0.419), (0.431, 0.451) and (0.36, 0.482).

2. The lighting device of claim 1, wherein proportion of the amounts of the white LEDs and the red LEDs is 5:3.

3. The lighting device of claim 2, wherein the amounts of the white LEDs and the red LEDs are respectively 5 and 3, and the positions of the LED array corresponds to a three-level array, denoted by A.

4. The lighting device of claim 3, wherein the positions of the white LEDs in the LED array correspond to the positions of the array elements a_{1,1}, a_{1,2}, a_{1,3}, a_{3,1} and a_{3,3} of the three-level array A and the positions of the red LEDs in the LED array corresponds to the positions of the array elements a_{2,1}, a_{2,2} and a_{2,3} of the three-level array A.

5. The lighting device of claim 3, wherein the positions of the white LEDs in the LED array correspond to the positions of the array elements a_{1,1}, a_{1,3}, a_{2,2}, a_{3,1} and a_{3,3} of the three-level array A and the positions of the red LEDs in the LED array corresponds to the positions of the array elements a_{2,1}, a_{2,3} and a_{3,2} of the three-level array A.

6. The lighting device of claim 3, wherein the positions of the white LEDs in the LED array correspond to the positions of the array elements a_{1,2}, a_{2,1}, a_{2,3}, a_{3,1} and a_{3,3} of the three-level array A and the positions of the red LEDs in the LED array corresponds to the positions of the array elements a_{1,1}, a_{1,3} and a_{3,2} of the three-level array A.

7. The lighting device of claim 3, wherein the positions of the white LEDs in the LED array correspond to the positions of the array elements a_{2,1}, a_{2,2}, a_{2,3}, a_{3,1} and a_{3,3} of the three-level array A and the positions of the red LEDs in the LED array corresponds to the positions of the array elements a_{1,1}, a_{1,3} and a_{3,2} of the three-level array A.

8. The lighting device of claim 1, further comprising an electrical connector electrically connecting to the white LEDs and the at least one red LED.

9. The lighting device of claim 1, further comprising at least one green LED, positioned at the bottom of the shell, which amount is between 1M to 3M, M denotes the constant, and the light emitted from which with the light emitted from the white LEDs and the at least one red LED forms the combined light emitted from the lighting device.

10. The lighting device of claim 9, wherein the proportion of the amount of the white LEDs, the at least one red LED and the at least one green LED is 4:3:1.

11. The lighting device of claim 10, wherein the amounts of the white LEDs, the at least one red LED and the at least one green LED are respectively 4, 3 and 1, and the positions of the LED array corresponds to another three-level array, denoted by B.

12. The lighting device of claim 11, wherein the positions of the white LEDs in the LED array correspond to the positions of the array elements b_{1,1}, b_{1,3}, b_{3,1} and b_{3,3} of the three-level array B, the positions of the red LEDs in the LED array corresponds to the positions of the array elements b_{2,1}, b_{2,2} and b_{2,3} of the three-level array B, and the position of the green LED in the LED array corresponds to the positions of the array elements b_{1,2} of the three-level array B.

13. The lighting device of claim 11, wherein the positions of the white LEDs in the LED array correspond to the positions of the array elements b_{1,1}, b_{1,3}, b_{3,1 and} b_{3,3} of the three-level array B, the positions of the red LEDs in the LED array corresponds to the positions of the array elements b_{2,1}, b_{2,3} and b_{3,2} of the three-level array B, and the position of the green LED in the LED array corresponds to the positions of the array elements b_{2,2} of the three-level array B.

14. The lighting device of claim 11, wherein the positions of the white LEDs in the LED array correspond to the positions of the array elements b_{2,1}, b_{2,3}, b_{3,1} and b3,3 of the three-level array B, the positions of the red LEDs in the LED array corresponds to the positions of the array elements b_{1,1}, b_{1,3} and b_{3,2} of the three-level array B, and the position of the green LED in the LED array corresponds to the positions of the array elements b_{1,2} of the three-level array B.

15. The lighting device of claim 11, wherein the positions of the white LEDs in the LED array correspond to the positions of the array elements b_{2,1}, b_{2,3}, b_{3,1} and b3,3 of the three-level array B, the positions of the red LEDs in the LED array corresponds to the positions of the array elements b_{1,1}, b_{1,3} and b_{3,2} of the three-level array B, and the position of the green LED in the LED array corresponds to the positions of the array elements b_{2,2} of the three-level array B.

16. The lighting device of claim 1 or claim 9, wherein the closed region comprises the six points of the XY coordinates (0.4476, 0.4074), (0.3485, 0.3517), (0.3101, 0.3163), (0.3127, 0.3290), (0.333, 0.333) and (0.313, 0.329) in 1931 CIE color space.

17. The lighting device of claim 1, further comprising at least one optical membrane positioned on the shell.

18. The lighting device of claim 17, wherein the optical membrane is a green polarizer.

19. The lighting device of claim 9, further comprising an electrical connector electrically connecting to the white LEDs, the at least one red LED and the at least one green LED.

20. The lighting device of claim 8 or claim 19, wherein the electrical connector is a screwed connector.

21. The lighting device of claim 1 or claim 9, further comprising a plurality of frames pivoting from a fixing device fixed on the bottom of the shell.
